(19) United States
(12) Patent Application Publication
(10) Pub. No.: US 2014/0326233 A1
(43) Pub. Date: Nov. 6, 2014

(54) DC PELLET BURNER ASSEMBLY

(71) Applicant: Joe Traeger, Mt. Angel, OR (US)

(72) Inventor: Joe Traeger, Mt. Angel, OR (US)

(21) Appl. No.: 14/120,192

(22) Filed: May 2, 2014

Related U.S. Application Data
(60) Provisional application No. 61/818,841, filed on May 2, 2013.

(51) Int. Cl. A47J 37/07

(52) U.S. Cl. CPC A47J 37/0704; A47J 37/0786
USPC 126/25 R; 126/10

(57) ABSTRACT

A wood-fuel pellet burner assembly, such as for barbecues, includes a gravity-feed pellet fuel hopper positioned in alignment with a pellet fuel intake and a perforated pellet fuel slide that extends to a combustion region. A DC ignitor has a heating element that extends into the combustion region, and a DC fan is positioned to direct a flow of air through the perforated pellet fuel slide and into the combustion region. A DC power source, such as a vehicle-grade 12-volt battery, is coupled to and powers the DC ignitor and the DC fan.

### RELATED APPLICATION

This application claims the benefit of provisional application No. 61/818,841, filed May 2, 2013.

### TECHNICAL FIELD

The present invention relates generally to wood pellet-burning barbecues, and, more particularly, to a wood pellet burner for use with such barbecues.

### BACKGROUND OF THE INVENTION

Wood pellet-burning barbecues are popular for outdoor cooking. Conventional wood pellet-burning barbecues, of the type described in U.S. Pat. No. 4,823,684, employ a motor-driven auger to provide a measured feed of wood pellets into a combustion region where the pellets are burned to provide heat and smoke to cook food.

An aspect of such conventional wood pellet-burning barbecues is that the motor that drives the auger can require a steady supply of significant power as provided by, for example, an AC electrical power source. While convenient in outdoor settings of many homes, the required AC power for such barbecues has limited their portability and use where convenient AC power is not available such as at parks, sporting events, some camping areas, etc.

### SUMMARY OF THE INVENTION

Therefore, an aspect of the present invention is to provide wood pellet burner assembly that provides operation of a wood pellet-burning barbecue without an AC power source. As a result, such a wood pellet burner assembly allows a wood pellet-burning barbecue to be used where AC power is not available, such as at parks, sporting events, some camping areas, etc., and can significantly enhance the portability of wood pellet-burning barbecues.

In one implementation, a pellet burner assembly according to the present invention includes a gravity-feed pellet fuel hopper positioned in alignment with a pellet fuel intake and a perforated pellet fuel slide that extends to a combustion region. A DC ignitor has a heating element that extends into the combustion region, and a DC fan is positioned to direct a flow of air through the perforated pellet fuel slide and into the combustion region. A DC power source, such as a vehicle-grade 12-volt battery, is coupled to and powers the DC ignitor and the DC fan. Such a wood pellet burner assembly allows a wood pellet-burning barbecue to be used where AC power is not available, such as at parks, sporting events, some camping areas, etc., and can significantly enhance the portability of wood pellet-burning barbecues.

### BRIEF DESCRIPTION OF THE DRAWINGS

FIG. 1 is a side elevation, with portions broken away, of a prior art wood pellet-burning barbecue.

FIG. 2 is side elevation of an implementation of a pellet burner assembly according to the present invention.

FIGS. 3 and 4 are sectional side views of the pellet burner assembly of FIG. 2 separately illustrating pellet fuel and airflow, respectively.

FIG. 5 is a plan view into a hopper of the pellet burner assembly of FIG. 2.

FIGS. 6 and 7 are top and bottom views of a perforated slide of the pellet burner assembly of FIG. 2.

FIG. 8 is a side elevation of a barbecue with the pellet burner assembly of FIG. 2.

FIG. 9 is a circuit schematic diagram of the pellet burner assembly.

### DETAILED DESCRIPTION OF THE INVENTION

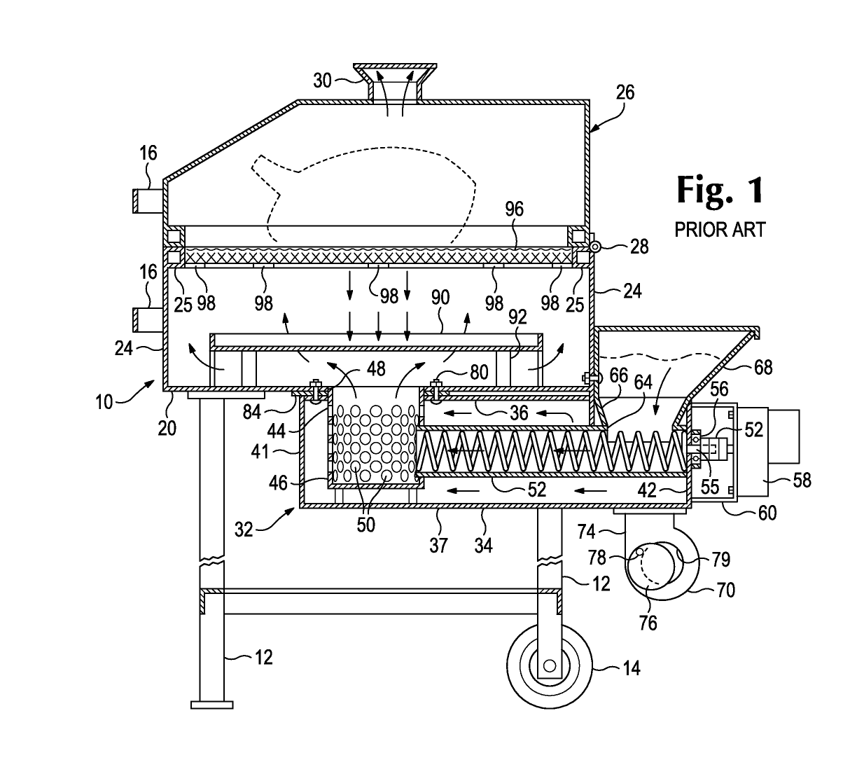

FIG. 1 is a side elevation, with portions broken away, of a prior art pellet-burning barbecue 8 described in U.S. Pat. No. 4,823,684. Barbecue 8 is configured to place the top of a pan 10 at a convenient working height above the ground, through legs 12 secured to and extending downwardly from the base of the pan 10. For convenience of moving, if desired, wheels 14 are provided rotatably journaled on the base of two of the legs in the barbecue. For moving purposes, the barbecue may be partially raised utilizing handles 16 connected to the pan whereby ground contact is solely through those legs having wheels 14, the barbecue then being rollable to the position desired.

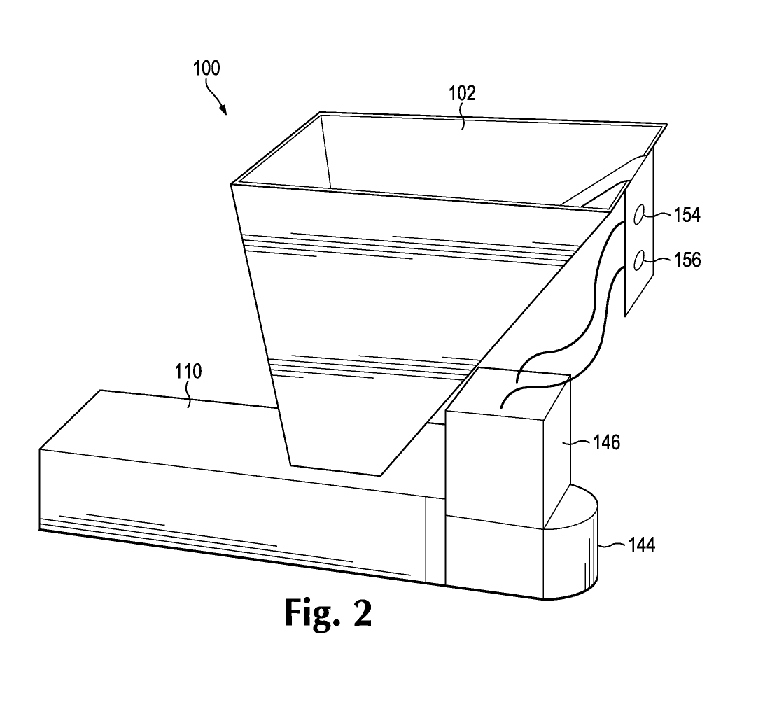

Pan 10 includes a bottom 20 and opposed side and end walls 22, 24 joined to bottom 20. The top of the pan may be reinforced as by framing 25. Pan 10 is open at the top. If desired, a hinged cover 26 may be included connected by hinges 28 to pan 10. The cover is swingable between a closed position where the cover closes off the top of the barbecue pan, as shown in FIG. 2, and an open position where the cover is swung to one side to expose the barbecue pan interior, as shown in FIG. 1. The cover may further include a ventilating hood as shown at 30.

A burner assembly 32 extends underneath the barbecue pan from approximately centrally of the pan to a position on one side thereof. In the specific embodiment of the invention disclosed, the burner assembly 33 includes an elongate housing 34 of substantially rectangular, i.e., square, cross section, and including top, bottom, and opposed side walls indicated at 36, 37, 38, and 39. The ends of the housing are closed off by end walls 41, 42.

Top wall 36 has a circular aperture 44 adjacent one end. Suitably secured as by welding within the housing and communicating with this aperture is a cylindrical fire pot 46 which is open at its top and closed at its bottom. The interior of the fire pot faces upwardly, and communicates with the interior of pan 10 through aperture 48 in bottom 20 of the pan. The cylindrical wall of the fire pot contains perforations 50.

With the construction described, the housing walls define a chamber extending along the interior of the housing and this chamber communicates through perforations 50 with the interior of the fire pot. Extending along the interior of housing 34 is a tube 52 having one end secured as by welding to the cylindrical wall of pot 46. The wall of the pot is cut out to provide an opening therein which communicates with the interior of tube 52. The opposite end of the tube is appropriately secured to end wall 42 of the housing.

Mounted within tube 52 is an elongate auger 54 terminating in a shaft 55. The shaft extends through wall 42 where it is supported in a bearing assembly 56. An electric gear motor 58 mounted on the end of the housing through bracket 60 has its output shaft connected through drive coupling 62 with the end of auger shaft 55.

Tube 52 is open at 64 and a wall 66 extending up from this opening provides a throat for the channelling of pellet fuel downwardly onto the auger to be fed thence by operation of the auger through the auger tube. A hopper 68 is supported on top of housing 34 which holds a supply of pellet fuel. The top wall of the housing is suitably cut away to place the base of the hopper in direct communication with the top of the throat defined by wall 66.

Supported on the underside of housing 34 approximately underneath the hopper is an electrically operated blower 70 having its discharge end connected through duct 74 with the chamber defined along the length of the interior of housing 34. A shutter 76 supported on the blower assembly by a pivot mounting 78 is adjustable to vary the degree of closure of intake 79 to the blower and, in this way, the amount of air flow produced by the blower through its discharge opening along the length of the housing.

The housing is supported on the underside of the pan through bolts 80 which extend upwardly from top wall 36 and through accommodating bores provided in the bottom of the pan, with securement completed using nuts screwed onto the protruding ends of the bolts. Gasket material 84 may be provided intermediate the top wall of the housing and the underside of the barbecue pan. Additional securement of the housing beneath the barbecue pan may be provided by securing a portion of the hopper to the side of the pan in an appropriate manner.

Disposed within the interior of the barbecue pan somewhat upwardly from the top of the fire pot is a nonperforate, metallic, baffle pan or plate shown at 90 including a floor and a raised shoulder extending about its perimeter. The baffle plate extends in a region disposed over the top of the fire pot and outwardly from this region to edges disposed inwardly somewhat from the side walls of the barbecue pan. The baffle plate is removably supported in this position as by legs 92 which may be joined either to the underside of the baffle pan or to the base of the barbecue pan with their opposite extremities unsecured. A food-support means or grill 96 is mounted within the interior of the barbecue pan and directly adjacent the top thereof, such grill being supported on support lugs 98 joined to the side walls of the barbecue pan.

To start up the barbecue, the grill is removed and the baffle pan tipped to an upright position which exposes the top of the fire pot. A small amount of wood pellets, i.e., a handful, are then placed in the fire pot together with combustible material such as paper, and the like. This is then lit, and combustion allowed to proceed for a short period of time such as two minutes or so. The baffle pan and grill may then be replaced in their operative positions, the air blower started, and the auger motor started. This produces forced-air circulation down the interior of housing 34 with the air blowing inwardly into the fire pot to support combustion of the material therein. The operation of the auger produces a gradual feed of replacement pellets to the fire pot, replacing material as such is burned. Normally a warmup period of only a few minutes is required after replacement of the grill and before cooking may proceed.

With the barbecue operating, food to be cooked may be placed on the grill. The blower produces forced-air circulation within the interior of the barbecue pan with heated air coming from the fire pot moving upwardly and around the baffle plate and thence circulating against and through the grill. Cooking may be performed with the cover in the closed position or with the cover open. With the cover closed, oven-like conditions are produced within the barbecue, and with the cover open, grill-like conditions are produced. The baffle plate on being heated radiates heat upwardly. Drippings from any food cooked are prevented from falling into the fire pot by the baffle plate which collects such material. With cooking concluded, the auger is stopped which stops feed of pellet material to the fire pot. With stoppage of pellet feed and with the blower turned off, combustion in the pot soon terminates.

FIGS. 2-4 illustrate a DC wood pellet burner assembly 100 operable, for example, as a general substitute for or alternative to burner assembly 32 described with reference to prior art pellet-burning barbecue 8 of FIG. 1.

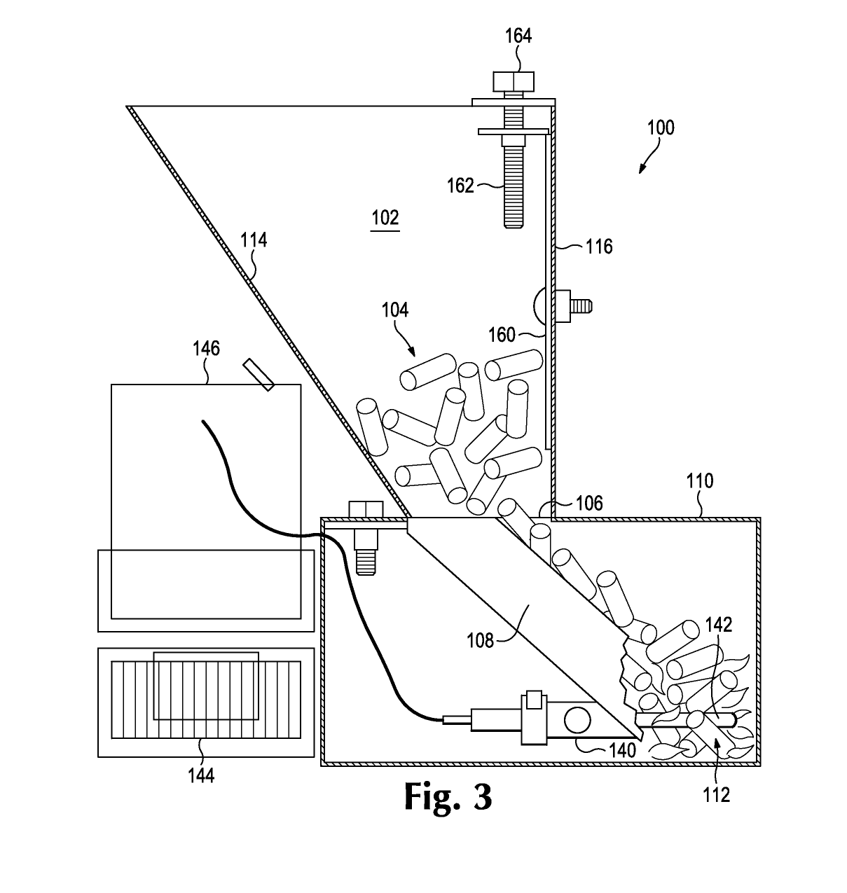

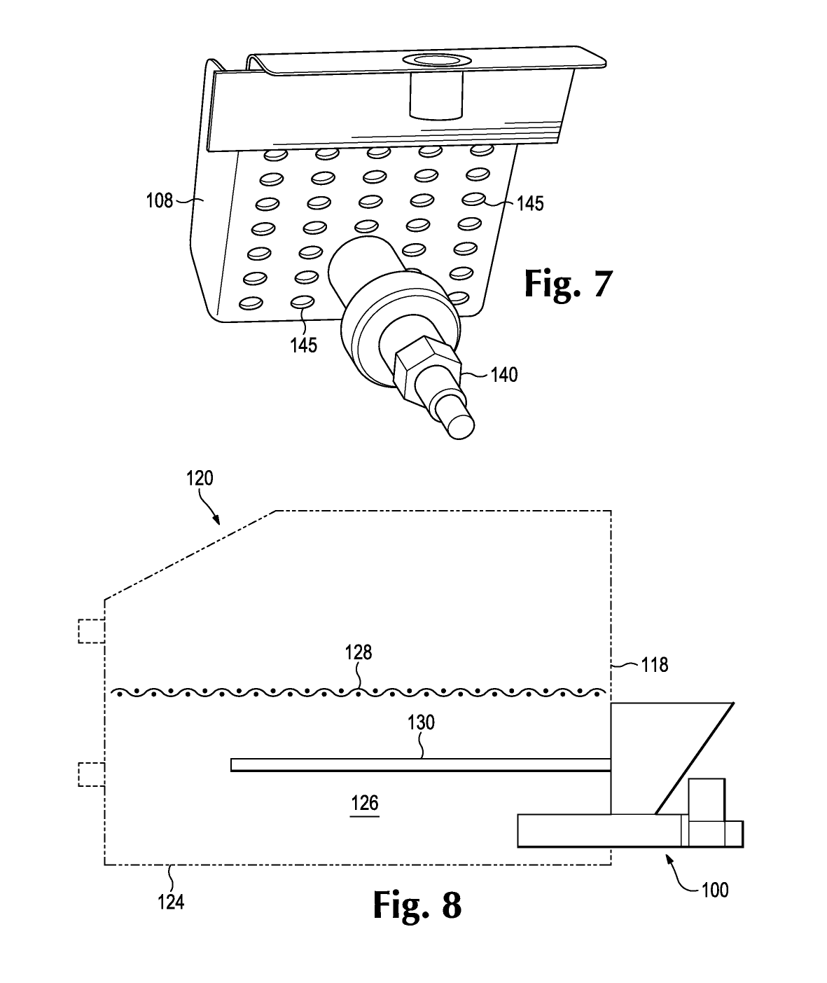

Pellet burner assembly 100 includes a pellet hopper 102 that receives and stores a supply of fuel (e.g., wood) pellets 104 (illustrated figuratively in FIG. 3—as is known in the art, pellets 104 are significantly smaller than illustrated) and feeds them through a pellet intake 106 and onto a perforated slide 108 in a burn tube 110 to be fed toward a combustion region 112. In the illustrated implementation, hopper 102 includes at least one inclined face 114 to provide gravity feed of pellets 104 into intake 106. Pellet burner assembly 100 includes a face 116 for mounting to a side 118 of a barbecue, such as a barbecue 120 (FIG. 8). Barbecue 120 is shown without support legs, as it would be configured in one portable configuration for use on a tabletop or other like surface, for example. It will be appreciated, however, that barbecue could alternatively be mounted on legs or a cart, for example.

In the illustrated implementation, face 116 is contiguous with hopper 102. It will be appreciated, however, that the mounting structure for securing pellet burner assembly 100 to barbecue could alternatively be distinct from hopper 102. Also, face 116 is illustrated as being substantially vertical to conform to a corresponding side 118 of barbecue 120 so that pellet burner assembly 100 may be secured to barbecue 120 by a pair of nuts and bolts 121 (one shown), or more, that extend through corresponding apertures (not shown) in the side 122 of barbecue 120.

Barbecue 120 includes a pan 124 with an interior volume 126 over which a grill 128, or other food-supporting structure (e.g., grate, nonperforate surface, etc.) extends to support food to be cooked such as by hot smoking or other indirect heat cooking. Side 118 includes an aperture (not shown) sized to receive burn tube 110 in a fitted relationship to that burn tube 110 extends into and combustion region 112 is positioned within the interior volume 126 of pan 124. A baffle pan or plate 130, substantially similar in operation to baffle pan or plate 90 (FIG. 1), extends partially across pan 122 in spaced relation above burn tube 110 and below grill 128.

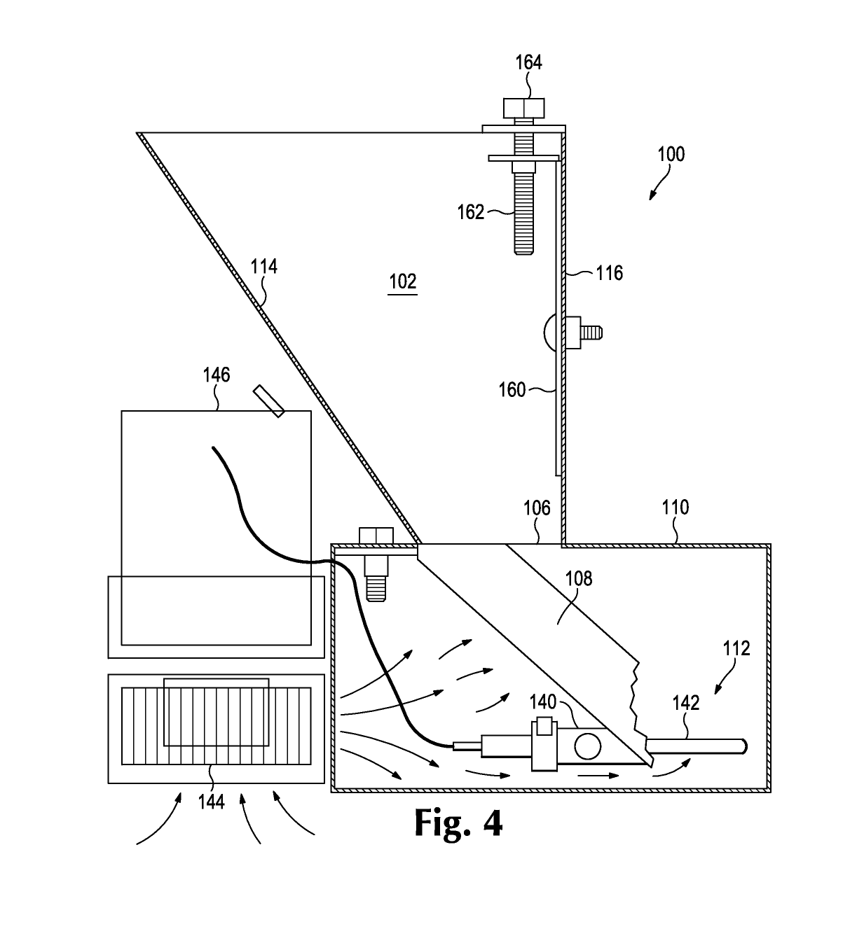

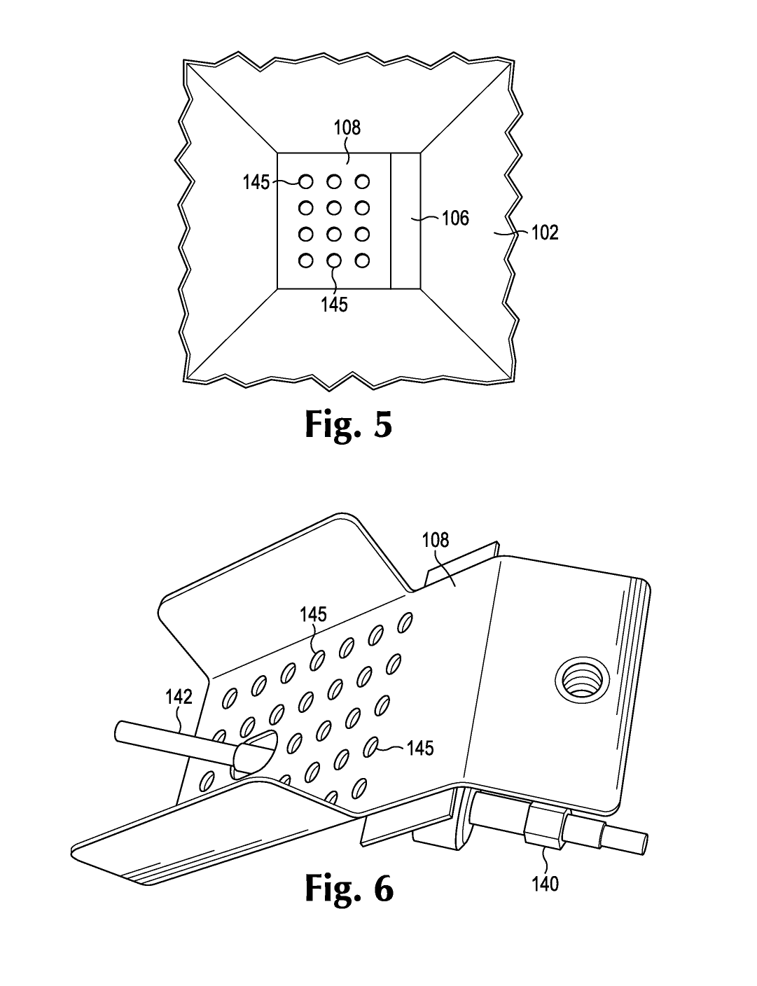

Pellet burner assembly 100 further includes a DC ignitor 140, such as a glow plug, having a heating element 142 that extends into combustion region 112 to ignite pellets 104, a DC fan 144 is positioned to direct a flow of air through perforations 145 (FIGS. 5-7) of perforated slide 108 to combustion region 108, and a DC power source 146, such as a vehicle-grade 12-volt battery.

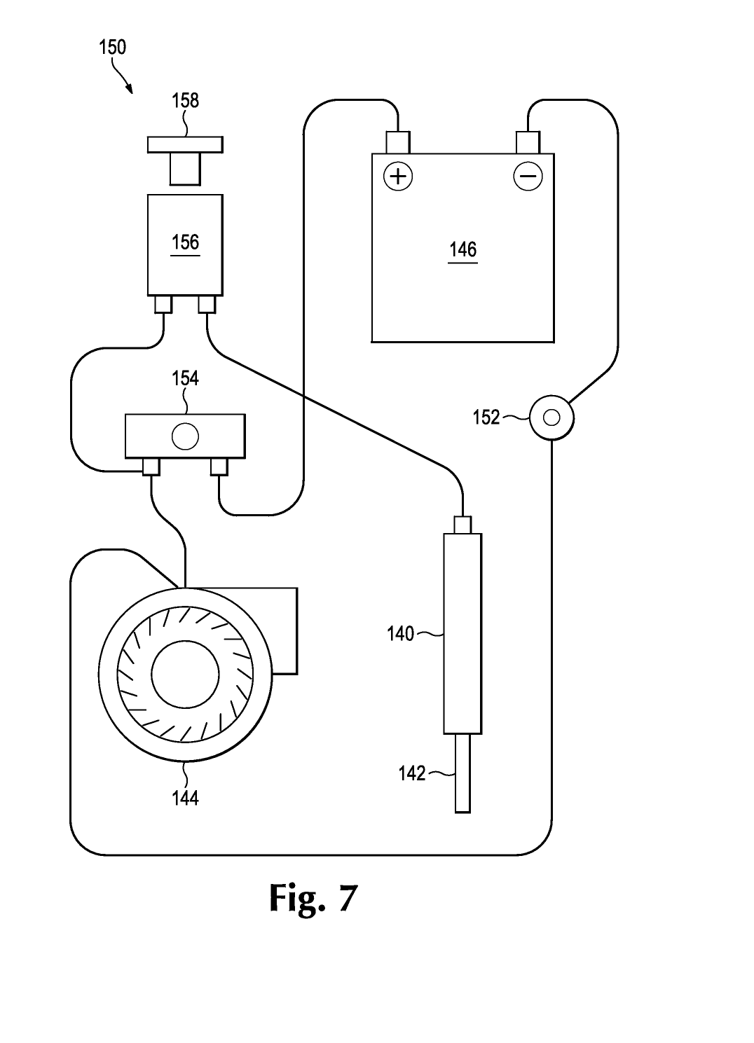

FIG. 9 is a schematic circuit diagram illustrating electrical system 150 of pellet burner assembly 100. Battery 146 is connected between a body grounding lug 152 and a user-operable power switch 154 that turns electrical system on or off. When on, power switch 154 provides power to fan 144 and to an ignitor activating switch 156, such as a normally open switch that is operable with a push-button 158 and is connected to ignitor 140. Upon a user switching power switch 154 to on, fan 144 is activated and power is delivered to ignitor activating switch 154. A user may then press push-button 158 for a period of time (e.g, approximately 2 minutes) to activate ignitor 140 until pellets 104 in combustion region 112 are ignited. The user may then release push-button 158, deactivating ignitor 140.

Once ignited, the air flow provided by fan 144 allow pellets 104 in combustion region 104 continue to burn and to be replenished automatically as addition pellets 104 drop through intake 106. Pellet burner assembly 100 includes a pellet feed control door 160 that is slidable along one face (e.g., face 116) to control the rate of flow of pellets 104 into combustion region 112, thereby controlling the cooking temperature of barbecue 120. In addition, feed control door 160 functions to close intake 106 so that burning of pellets 104 can be stopped by stopping the flow of pellets 104 into combustion region 112. In the implementation illustrated in FIGS. 3 and 4, feed control door 160 is in threaded engagement with a postioning screw 162 that a user can turn by way of a knob 164 to slide door 160 up or down.

One of skill in the art will recognize that the concepts taught herein can be tailored to a particular application in many other ways. In particular, those skilled in the art will recognize that the illustrated examples are but one of many alternative implementations that will become apparent upon reading this disclosure.

1. A pellet burner assembly, comprising:
a gravity-feed pellet fuel hopper positioned in alignment with a pellet fuel intake and a perforated pellet fuel slide that extends to a combustion region;
a DC ignitor that extends with a heating element that extends into the combustion region;
a DC fan positioned to direct a flow of air through the perforated pellet fuel slide and into the combustion region; and
a DC power source to selectively power the DC ignitor and the DC fan.

2. The assembly of claim 1 in which the pellet fuel intake has an intake opening size and the assembly further comprises a user-operable pellet feed control door to vary the intake opening size.

3. The assembly of claim 2 in which the pellet feed control door is further operable to close the intake opening.

4. The assembly of claim 2 in which the hopper includes at least one wall that extends to the intake opening and the pellet feed control door is slidable along the at least one wall door to vary the intake opening size.

5. The pellet burner assembly of claim 1 further comprising a user-operable ignitor switch in communication between the DC power source and the DC ignitor.
